(19) United States
(12) Patent Application Publication
(10) Pub. No.: US 2013/0286953 A1
(43) Pub. Date: Oct. 31, 2013

(54) APPARATUS, SYSTEM, AND METHOD FOR CELL RANGE EXPANSION IN WIRELESS COMMUNICATIONS

(71) Applicants: Henry Hui Ye, Ma On Shan (HK); Kai Zhang, Ma On Shan (HK)

(72) Inventors: Henry Hui Ye, Ma On Shan (HK); Kai Zhang, Ma On Shan (HK)

(73) Assignee: Hong Kong Applied Science and Technology Research Institute Co., Ltd., Shatin (HK)

(21) Appl. No.: 13/570,123

(22) Filed: Aug. 8, 2012

Related U.S. Application Data
(60) Provisional application No. 61/639,707, filed on Apr. 27, 2012.

(51) Int. Cl. H04W 72/04

(52) U.S. Cl. 370/329

(57) ABSTRACT

The present invention is directed to systems and methods which accommodate OTA delays exceeding the delay associated with a 100 km transmission (more than approximately 0.667 ms) while still affording the full processing time required by both the UE and the eNode B equipment.

### CROSS-REFERENCE TO RELATED APPLICATIONS

This application claims priority to U.S. Provisional Application No. 61/639707, filed Apr. 27, 2012, the entire contents of which is specifically incorporated herein by reference without disclaimer.

### TECHNICAL FIELD

The present invention relates generally to wireless communications and, more particularly, to apparatuses, systems, and methods for cell range expansion in wireless communications.

### BACKGROUND OF THE INVENTION

Fast retransmission requirements have been included in wireless communications standards such as LTE, WiMAX, and HSPA to improve system performance. For example, in LTE, the retransmission latency requirement is 8 ms. This means that the total processing time, on both the transmitter side and the receiver side, plus the over-the-air (“OTA”) delay should be less than 8 ms in LTE systems. The LTE standard states that a cell range of up to 100 km is supported, which translates to a maximum 2-way OTA delay of about 0.667 ms. For certain applications, such as using LTE as backhaul access for in-flight Wi-Fi service, the distance between the LTE User Equipment (“UE”) and the base station (“eNode B”) can be 200 km or more. Thus, traditional LTE systems cannot be used for such applications, because the OTA delay would be more than the allotted 0.667 ms, which would limit the available processing time for the UE and eNode B equipment. Additional limitations include the design of LTE preamble signals as defined in the LTE standard, and maximum Uplink Advanced Time supported in UE implementations as defined under the LTE standard.

In certain systems, uplink signals from different UEs arrive at eNode B at roubly the same time. This may be usefull to maintain the orthogonality between signals from different UEs, and to simplify eNode B design through, e.g., sharing of the same Fast Fourier Transform (“FFT”) engine. In common LTE systems, the initial uplink synchronization is achieved using Preamble Random Access Channel (“PRACH”) procedures. Even when the uplink synchronization is established, it may eventually be lost for various reasons, including movement of the UE or inaccuracy of local oscillators in the UEs or eNode B. Therefore, uplink timing maintenance is required, and mechanisms for uplink timing maintenance are described in some communication standards, such as the LTE standard.

In general, the timing synchronization and maintenance process begins when a UE receives a signal from eNode B. The signal may include timing information, which UE uses to determine downlink timing. UE may then return a Preamble signal aligned with its downlink receiving timing. eNode B then detects the preamble, estimates the latency, and then instructs UE to advance its subsequent uplink transmission time by twice the one-way latency. With the timing advancement, the UE's subsequent uplink transmission is synchronized. The synchronization may be lost if the UE moves to a location where the latency is different. Thus, eNode B is generally configured to detect timing drift and send periodic timing updates to UE.

Fast Retransmission is used in many packet-based wireless communication standards, such as CDMA EVDO, HSPA, and LTE to improve performance. In these systems, if the receiver can decode the packet, it sends back an ACK signal. Otherwise, the receiver replies with a NACK signal. If a NACK is received by the transmitter, it will retransmit the packet. In order to support delay-sensitive applications, the retransmission interval is usually very small. For example, LTE systems only use a retransmission of eight subframes (8 ms). A certain minimum amount of time is required by both UE and eNode B for processing uplink and downlink signals. Any over-the-air (“OTA”) delay uses up a portion of that processing time. Thus in many systems, an OTA limit is set, which effectively limits the possible range of communication between eNode B and UEs. For example, in LTE, the typical OTA limit is 68 ms, which is roughly equivalent to a 100 km radius from eNode B.

### BRIEF SUMMARY OF THE INVENTION

The present invention is directed to systems and methods which accommodate OTA delays exceeding the delay associated with a transmission across a 100 km distance (more than approximately 0.667 ms) while still affording the full processing time required by both the UE and the eNode B equipment. In one embodiment, a plurality of transmission states are defined by the range of a UE from eNode B. For example, states may include a “Regular State,” a “Transition State,” and an “Extended State.” Such embodiments may eliminate or significantly reduce collisions of signals received by eNode B from UEs located within the 100 km transmission zone (Regular State) and those received from UEs located outside of the 100 km transmission zone (transition state and/or extended state). Additionally, the present embodiments may reduce misdetection of transmission zones.

In one embodiment, a method for cell range expansion is wireless communications includes receiving a communication from a base station in a wireless communication network. For example, a wireless receiver in e.g., a mobile smartphone may receive the communication. Additionally, the method may include determining a distance from the base station in response to the communication. The distance may be determined using a data processing device loaded with executable code which comprises instructions for causing the processing device to determine the distance. Additionally, the method may include setting a communication timing state according an estimated distance from the base station and internal transmission timing advance capability. Setting may also be accomplished by the processing device. Finally, the method may include sending a response to the base station according to a timing scheme defined according to communication timing state.

In one embodiment, the method may also include setting a first communication timing state when the desistance from the base station is within a first predetermined threshold distance. The timing scheme does not modify the timing of the response to the base station when the first communication timing state is set. Additionally, the method may include setting a second communication timing state when the distance is greater than the first predetermined threshold distance. The timing scheme shortens the timing of the response to the base station by one subframe length and then adds a transition compensation delay when the second communication timing state is set.

In an embodiment, the method may also include setting a third communication timing state when the distance is greater than a second predetermined threshold distance, the second predetermined threshold distance being greater than the first predetermined threshold distance. In such an embodiment, the timing scheme shortens the timing of the response to the base station by one subframe length.

The method may also include holding the response to the base station until a second communication is received from the base station, and then responding to the base station according to the timing scheme. In PDSCH systems, the method may include automatically sending a NACK in response to a first PDSCH communication received from the base station, and waiting for the base station to respond with a second PDSCH communication before sending a response to the base station. Similarly, in PUSCH systems, the method may include automatically setting the transmitter to mute in response to a first command from the base station, and waiting for the base station to retransmit the command before sending a PUSCH response to the base station.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a schematic diagram illustrating one embodiment of a system for cell range expansion in wireless communications;

FIG. 2 is a schematic block diagram of one embodiment of an apparatus for cell range expansion in wireless communications;

FIG. 3 is a graphical timing diagram of two-way wireless communication in three ranges of distance between a UE device and an eNode B device;

FIG. 4 is a graphical timing diagram illustrating a timing of two-way wireless communications according to a method for cell range expansion in wireless communications;

FIG. 5 is a graphical representation of a modified method for uplink data channel PUSCH configured for cell range expansion in wireless communications;

FIG. 6 is a graphical representation of a modified method for downlink PDSCH transmission configured for cell range expansion in wireless communications; and

### DETAILED DESCRIPTION OF THE INVENTION

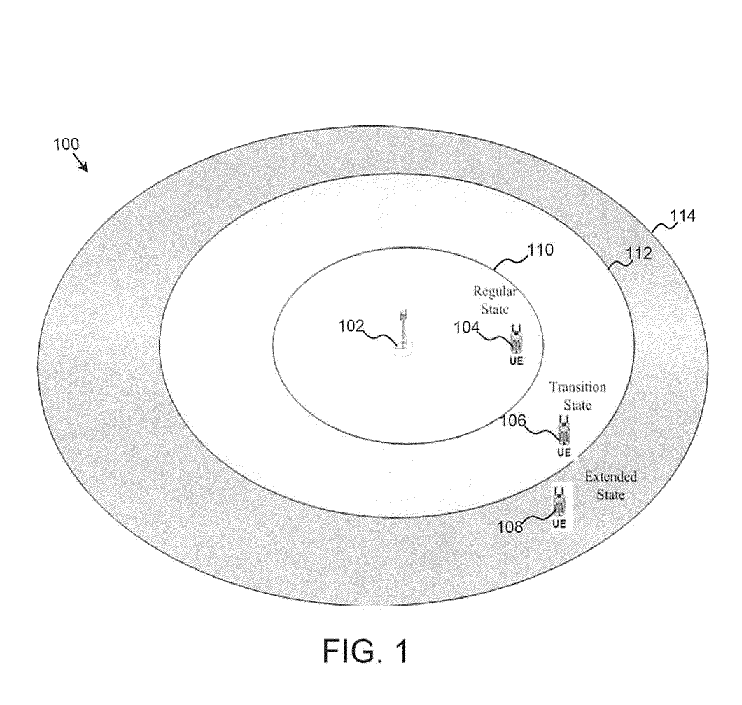

FIG. 1 is a schematic diagram illustrating one embodiment of system 100 for cell range expansion in wireless communications. In the depicted embodiment, system 100 includes base station (eNode B) 102 configured for wireless communications with one or more User Equipment (UE) devices 104-108. In one embodiment, first UE device 104 may be located within a normal range of eNode B 102. As described above, in LTE systems, the normal range 110 from eNode B 102 is 100 km as defined by LTE standards. In other communication systems, such as WiMAX, the normal range 110 may be different than in LTE standards. As illustrated in FIG. 1, UE 104 may determine that it is within the normal range 110 of eNode B 102 and set a regular state setting in its communication circuitry.

Additionally, system 100 includes two UE devices 106, 108 that are located outside of the normal range 110. For example, UE 108 may be located in extended range region 114 and UE 106 may be located in transition region 112. One of ordinary skill in the art will recognize that a variety of ranges or regions may be defined according to the present embodiments. In the embodiment of FIG. 1, UE 106 sets a transition state setting in its communication circuitry and UE 108 sets an extended state setting in its communication circuitry.

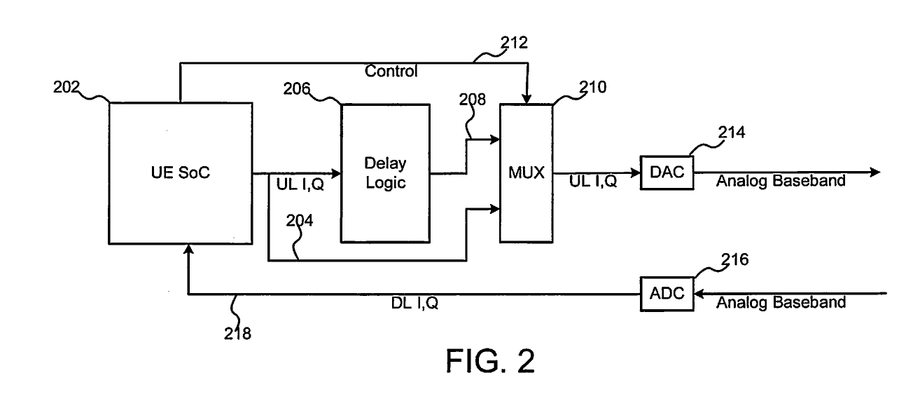

FIG. 2 is a schematic block diagram of one embodiment of an apparatus for cell range expansion in wireless communications. In one embodiment, FIG. 2 represents at least a portion of the communication circuitry of UE devices 104-108. In one embodiment, the apparatus includes UE system-on-chip (SoC) device 202. In various embodiments, SoC 202 may be a programmable data processor, Field Programmable Gate Array (FPGA), Digital Signal Processor (DSP), Programmable Logic Chip (PLC), or the like. UE SoC 202 may produce an output 204 which is coupled to delay logic device 206 and to multiplexer (“MUX”) 210. Additionally, a control line 212 may be coupled between UE SoC 202 to MUX 210 for controlling whether MUX 210 used output 204 from UE SoC 202 or output 208 from Delay Logic 206. MUX 210 then generates an output for which is converted by Digital to Analog Converter (“DAC”) device 214 for communication to eNode B 102.

Additionally, UE SoC 202 may be coupled to Analog to Digital Converter (“ADC”) 216 to receive data and commands from eNode B 102 on input line 218. In one embodiment, UE SoC 202 may use information derived from the data and commands received on input line 218 to determine whether UE 104-108 is located in normal range 110, transition range 112, extended range, or some other range from eNode B 102. Then, UE SoC 202 may use such information to set a state setting within UE SoC 202 to one of a plurality of states. For example, the states may include “Regular” state, “Transition” state, and “Extended” state. In one embodiment, the state of UE SoC 202 may determine the timing of communications sent back to eNode B 102. For example, in regular state, UE 104 may send communications to eNode B 102 according to the conventional timing as defined. In extended state, UE SoC 202 may adjust the timing for the response to a 1-subframe-sooner timing advance. In a particular embodiment, UE SoC 202 may cause the UE 108 to respond to eNode B 102 1 ms sooner than it would in regular state. In the transition state, UE SoC 202 of UE 106 may also set a 1-subframe timing advance, but in addition may add some delay using either internal delay or delay logic 206, so that the timing of the response is greater than possible in normal state, but less than the timing advance in extended state.

UE SoC 202 may then set controls on MUX 210 over control line 212 according to the state of SoC 202 to determine whether delay will be used or not. In a further embodiment, UE SoC 202 may include a further control line (not shown) for setting a delay time in delay logic 206. Alternatively, delay logic 206 may be preset to a predetermined delay period.

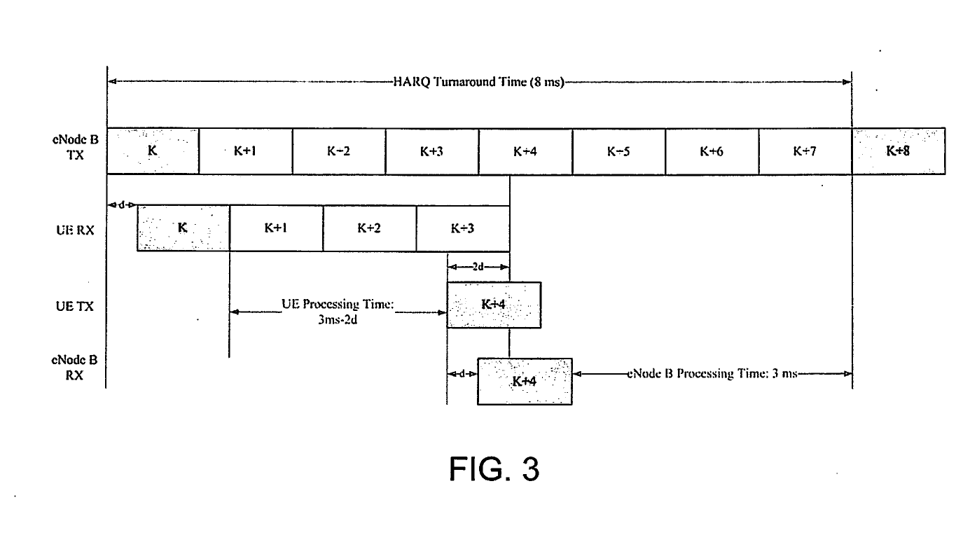

FIG. 3 is a graphical timing diagram of two-way wireless communication between UE device 104-108 and an eNode B 102. In particular, FIG. 3 illustrates one embodiment of a LTE timing diagram. In such an embodiment, the total round-trip communication turnaround time is completed within an 8 ms time period. The 8 ms time period may be broken into eight equal Subframe Lengths (SFL), where each SFL is 1 ms.

On the first row, eNode B 102 may transmit a command at interval K to UE 104. The OTA delay for the transmission between eNode B 102 and UE 104 is represented by “d”. Thus, d ms later, UE 104 receives the command and starts processing the command. Ordinarily, UE 104 should have three SFLs to process the command, but that time is shortened by the total round trip OTA delay of 2d ms. Previous UE devices in LTE systems were configured to handle processing times where the total OTA delay of 2d is less than or equal to 0.667 ms. In one embodiment, this time delay corresponds to total distance of 100 km between eNode B 102 and UE 104.

Thus, UE 104 transmits a response at K+4−2d ms in order to get the timing for eNode B 102 processing times correct and allow for synchronization of communications between UE 104 and eNode B 102. It can be appreciated that as the distance between eNode B 102 and UE 106, 108 exceeds normal range 110, the OTA delay 2d may be so long that the processing time is insufficient for UE 106, 108 to process the command and prepare a response.

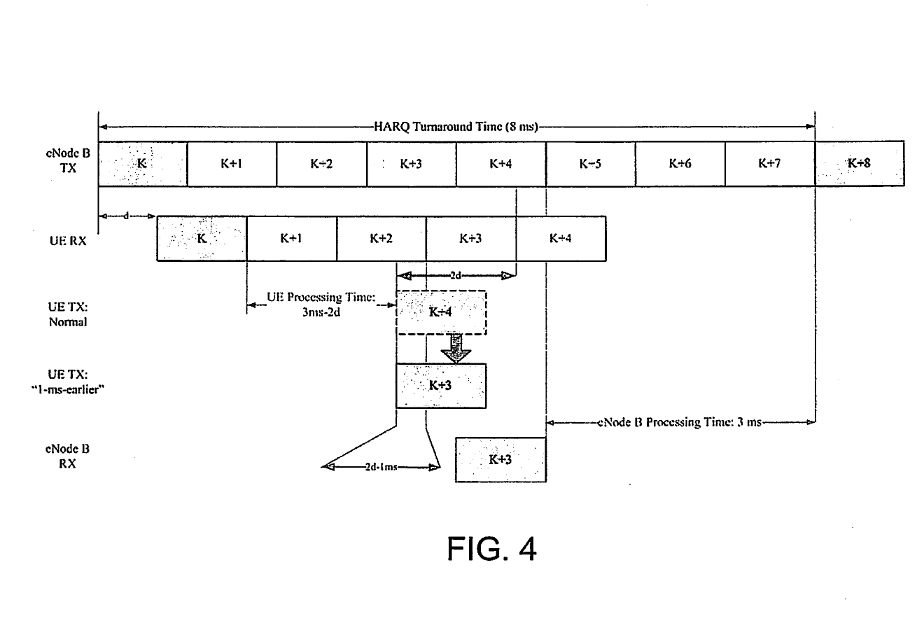

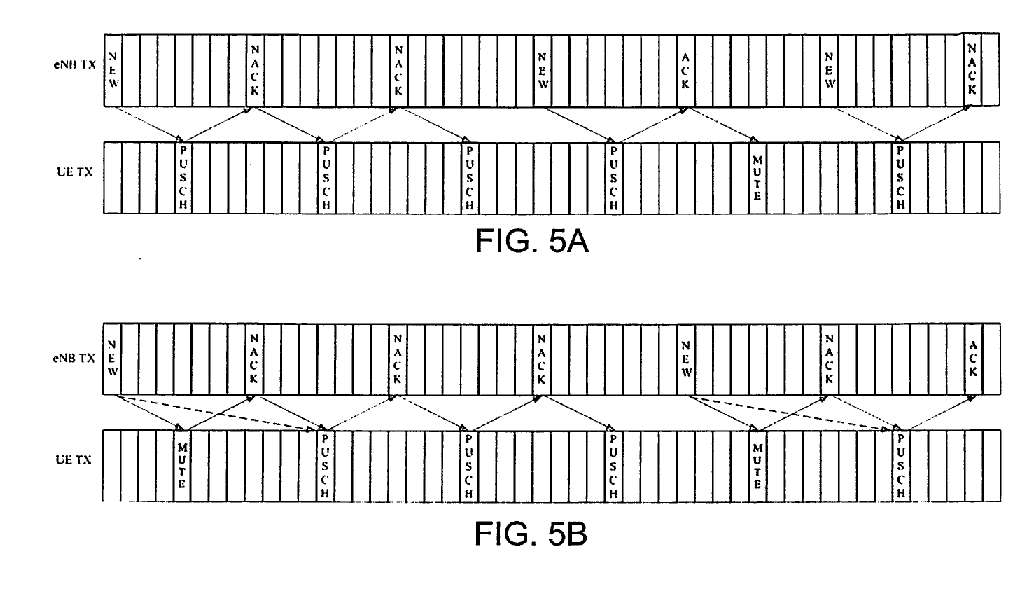

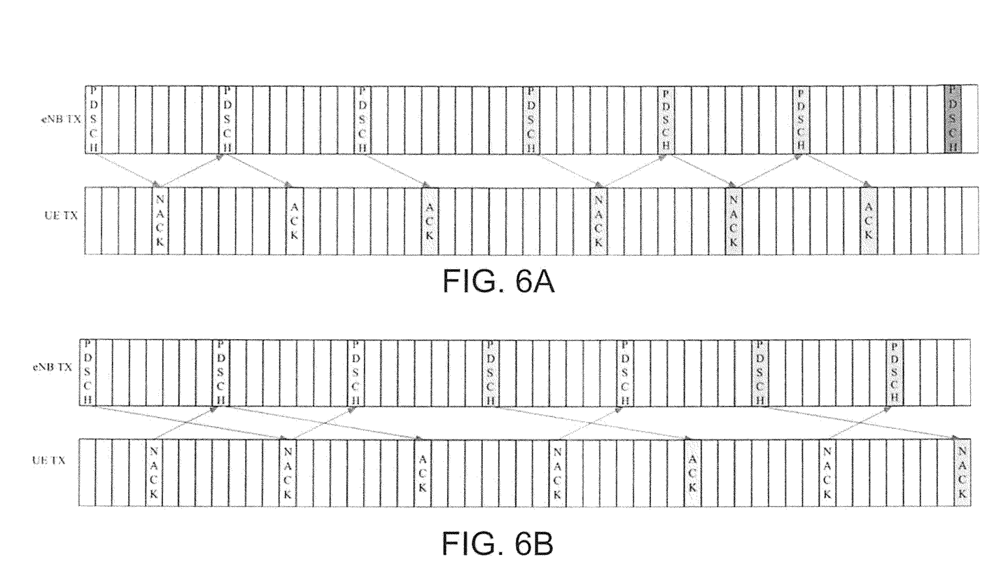

FIG. 4 is a graphical timing diagram illustrating a timing of two-way wireless communications according to a method for cell range expansion in wireless communications. In this embodiment, UE SoC 202 may be configured to set a “1-subframe-earlier” flag when it determines that the UE 106, 108 is outside of normal range 110. As described further in FIGS. 5A -5B, on the uplink data channel UE 106, 108 may hold a PUSCH packet transmission until eNode B 102 sends a retransmit command. On the downlink, as described in FIGS. 6A-6B, UE 106, 108 may be configured to always transmit a NACK in response to a first received PDSCH packet from eNodeB 104, thus causing eNode B 102 to retransmit the PDSCH packet. This allows UE 106, 108 to have a full 3 ms time period to process the response, and then communicate a timely response to the second command from eNode B 102. Although this may cause some delay because eNode B must retransmit the command, it enables the UE to effectively increase the transmission range to twice the normal range 110 or more, because it allows UE 106, 108 to synchronize communications with eNode B 102 even though the OTA delay is so long that UE 106, 108 would ordinarily not have sufficient processing time.

FIGS. 5A-B is a graphical representation of a modified method for uplink data channel PUSCH configured for cell range expansion in wireless communications. In FIG. 5A illustrates a normal uplink data channel PUSCH command and response schedule. This schedule may be used for UE 104, which is within normal range 110. In one embodiment, eNode B 102 sends a command for a new packet transmission to UE 104. In response, UE 104 may process the command and generate a PUSCH packet within a predetermined time frame. If eNode B 102 fails to decode a packet, it may send a NACK command to UE 104 for retransmission of the packet. In response, UE 104 may retransmit the PUSCH packet. ENode B 102 will continue to send a NACK command until a packet is decoded correctly, at which time eNode B 102 may either: send an ACK command and set UE 104 to mute, or send another command for a new packet.

FIG. 5B illustrates a modified scheme for cell range expansion in wireless communications. In this embodiment, UE SoC 202 may set UE 106, 108 to mute when receiving commands for new packet transmissions due to insufficient time to prepare the PUSCH new transmission. Thus, UE 106, 108 holds it's the PUSCH transmission until it receives a retransmit command from eNode B 102. Having the PUSCH packet prepared in response to the new packet command, UE 106, 108 immediately transmits the PUSCH packet at the prescribed time in response to the retransmit command from eNode B 102. If the PUSCH packet is decoded correctly , eNode B 102 may either: send an ACK command and set UE 104 to mute, or send another command for a new packet. If the PUSCH packet is not decoded correctly, eNode B 102 may send a NACK retransmit command to UE 106, 108 until a correct PUSCH packet is decoded.

FIGS. 6A-6B is a graphical representation of a modified method for downlink PDSCH packet transmission configured for cell range expansion in wireless communications. As illustrated in FIG. 6A, for communications between eNode B 102 and UE 104, which is within normal range 110, eNode B 102 may transmit a PDSCH packet to UE 104. If UE 104 can decode the PDSCH packet correctly, it will send back an ACK command. If UE 104 cannot decode the PDSCH packet correctly, it will send a NACK command to eNode B 102 for retransmission of the PDSCH packet.

As shown in FIG. 6B, UE 106, 108 may be configured to always transmit a NACK command in response to any new PDSCH packet transmission from eNode B 102, because UE 106, 108 may not have time to decode the PDSCH packet by the time the UE 106, 108 is required to send an ACK/NACK response. In response to retransmission of the PDSCH packet, UE 106, 108 will send an ACK/NACK response based on the decoding results of the previous transmission of the same PDSCH packet.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
receiving, at a wireless receiver, a communication from a base station in a wireless communication network;
determining, with a processing device, a distance from the base station in response to the communication; and
setting, with a processing device, a communication timing state according an estimated distance from the base station and internal transmission timing advance capability;
sending, over a wireless transmitter, a response to the base station according to a timing scheme defined according to communication timing state.

2. The method of claim 1, further comprising setting a first communication timing state when the desistance from the base station is within a first predetermined threshold distance.

3. The method of claim 1, wherein the timing scheme does not modify the timing of the response to the base station when the first communication timing state is set.

4. The method of claim 2, further comprising setting a second communication timing state when the distance is greater than the first predetermined threshold distance.

5. The method of claim 4, wherein the timing scheme shortens the timing of the response to the base station by one subframe length and then adds a transition compensation delay when the second communication timing state is set.

6. The method of claim 4, further comprising setting a third communication timing state when the distance is greater than a second predetermined threshold distance, the second predetermined threshold distance being greater than the first predetermined threshold distance.

7. The method of claim 6, wherein the timing scheme shortens the timing of the response to the base station by one subframe length.

8. The method of claim 1, further comprising holding the response to the base station until a second communication is received from the base station, and then responding to the base station according to the timing scheme.

9. The method of claim 1, further comprising automatically sending a NACK in response to a first PDSCH communication received from the base station, and waiting for the base station to respond with a second PDSCH communication before sending a response to the base station.

10. The method of claim 1, further comprising automatically setting the transmitter to mute in response to a first command from the base station, and waiting for the base station to retransmit the command before sending a PUSCH response to the base station.

11. A non-transitory computer program product comprising a computer readable medium having computer usable program code executable to perform operations for cell range expansion in wireless communications, the operations comprising:
receiving, at a wireless receiver, a communication from a base station in a wireless communication network;
determining, with a processing device, a distance from the base station in response to the communication; and
setting, with a processing device, a communication timing state according an estimated distance from the base station and internal transmission timing advance capability;
sending, over a wireless transmitter, a response to the base station according to a timing scheme defined according to communication timing state.

12. A system comprising:
a base station configured for wireless communications; and
a UE device configured for wireless communications with the base station, the UE device comprising:
a wireless receiver configured to receive a communication from a base station in a wireless communication network;
a processing device coupled to the wireless receiver, the processing device configured to:
determine a distance from the base station in response to the communication; and
to set a communication timing state according an estimated distance from the base station and internal transmission timing advance capability; and
a wireless transmitter coupled to the processing device, the wireless transmitter configured to send a response to the base station according to a timing scheme defined according to communication timing state.

13. The system of claim 12, wherein the processing device is further configured to set a first communication timing state when the desistance from the base station is within a first predetermined threshold distance.

14. The system of claim 12, wherein the timing scheme does not modify the timing of the response to the base station when the first communication timing state is set.

15. The system of claim 13, wherein the processing device is further configured to set a second communication timing state when the distance is greater than the first predetermined threshold distance.

16. The system of claim 15, wherein the timing scheme shortens the timing of the response to the base station by one subframe length and then adds a transition compensation delay when the second communication timing state is set.

17. The system of claim 15, wherein the processing device is further configured to set a third communication timing state when the distance is greater than a second predetermined threshold distance, the second predetermined threshold distance being greater than the first predetermined threshold distance.

18. The system of claim 17, wherein the timing scheme shortens the timing of the response to the base station by one subframe length.

19. The system of claim 12, wherein the UE is further configured to hold the response to the base station until a second communication is received from the base station, and then responding to the base station according to the timing scheme.

20. The system of claim 12, wherein the UE is configured to automatically send a NACK in response to a first PDSCH communication received from the base station, and waiting for the base station to respond with a second PDSCH communication before sending a response to the base station.

21. The system of claim 12, wherein the UE is configured to automatically set the transmitter to mute in response to a first command from the base station, and waiting for the base station to retransmit the command before sending a PUSCH response to the base station.
